(19) United States
(12) Patent Application Publication
(10) Pub. No.: US 2025/0023500 A1
(43) Pub. Date: Jan. 16, 2025

(54) MULTI-LEVEL INVERTER USING WIDE-BAND-GAP SEMICONDUCTOR DEVICES IN A POWER TOOL

(71) Applicant: MILWAUKEE ELECTRIC TOOL CORPORATION, Brookfield, WI (US)

(72) Inventor: Donald J. Truettner, Waukesha, WI (US)

(21) Appl. No.: 18/717,068

(22) PCT Filed: Dec. 9, 2022
(86) PCT No.: PCT/US2022/081264

§ 371 Date: Jun. 6, 2024

Related U.S. Application Data
(60) Provisional application No. 63/292,587, filed on Dec. 22, 2021.
(60) Provisional application No. 63/288,285, filed on Dec. 10, 2021.

(51) Int. Cl. H02P 27/06; B25F 5/00; H02K 7/14; H02K 11/33; H02M 7/483

(52) U.S. Cl. CPC H02P 27/06; B25F 5/00; H02K 7/14; H02K 11/33; H02M 7/4837

(57) ABSTRACT

A power tool including a motor, a power source interface configured to connect to a power source, and a printed circuit board (“PCB”) electrically connected to the motor and the power source interface. The PCB includes a three-level or greater inverter configured for controlling power supplied by the power source to the motor.

### RELATED APPLICATIONS

This application claims the benefit of U.S. Provisional Patent Application No. 63/288,285, filed Dec. 10, 2021, and U.S. Provisional Patent Application 63/292,587, filed Dec. 22, 2021, the entire content of each of which is hereby incorporated by reference.

### FIELD

Embodiments described herein relate to an inverter for a power tool.

### SUMMARY

An inverter is a power electronic device or circuitry that changes direct current (DC) voltage into alternating current (AC) voltage or an approximation of AC voltage. The resulting AC frequency obtained depends on the particular device employed. Inverters include or are connected to semiconductor switches, filter components (e.g., capacitors and inductors), control circuits, etc. In some embodiments, semiconductor switches are modulated at high frequency to reproduce an approximately AC waveform. However, when the semiconductor switches change state (e.g., from high to low), the switches incur a loss of power. Higher voltages sustained by the semiconductor switches typically result in larger losses. Moreover, switches fabricated from Silicon (Si) switch much slower than those switches fabricated from semiconductors like Gallium Nitride (GaN) or Silicon Carbide (SiC). Also, high voltage semiconductor switches typically have larger on state resistances, which results in power losses (i.e., switching and conduction losses). In some embodiments, to minimize the switching losses in Si the modulation frequency is kept at a modest value (e.g., 10 kHz to 30 kHz).

GaN and SiC are wide-bandgap (WBG) semiconductors. These devices, due to there much lower characteristic capacitance, can switch at much higher frequencies. Generally, silicon has an energy band gap of about 1.1 electron-volts (eV). WBG semiconductors may have an energy band gap of about 3 eV or greater. However, in some embodiments, the WBG semiconductors have an energy band gap that is less than 3 eV. Generally, the wider the energy band gap, the higher the critical field, which means that breakdown voltage may be larger for the same size WBG semiconductor formed device, relative to a silicon-based device. These higher frequencies allow passive components like capacitors and inductors to decrease in both their electrical (i.e., capacitance or inductance) and physical size. Such a size reduction results in reduced product weight and size along with an increase in power density.

Embodiments disclosed herein provide a power tool including a motor, a power source interface configured to connect to a power source, and a printed circuit board (“PCB”) electrically connected to the motor and the power source interface. The PCB includes a three-level or greater inverter configured for controlling power supplied by the power source to the motor.

In some aspects, the three-level or greater inverter is a flying capacitor multi-level (“FCML”) inverter.

In some aspects, a switching frequency of the three-level or greater inverter is a multiple of a fundamental switching frequency of the three-level or greater inverter, and a level of the three-level or greater inverter is a multiplier of the fundamental switching frequency.

In some aspects, the three-level or greater inverter is a three-level inverter, a five-level inverter, a seven-level inverter, a nine-level inverter, or an eleven-level inverter.

In some aspects, during operation of the three-level or greater inverter, a modulation voltage between two levels is given by V_{bus}/(N−1), where N is the number of levels.

In some aspects, the power tool includes an inductor and a capacitor at an output of the three-level or greater inverter.

In some aspects, a pulse frequency seen by the inductor is given by (N−1)f_{sw}, where f_{sw} is the switching frequency of at least one switch of the three-level or greater inverter.

In some aspects, an inductor ripple current of the three-level or greater inverter is defined according to Δi_{L}=0.25V_{BUS}/(N−1)²f_{sw}L, where L is the inductance of the inductor and V_{BUS} is a bus voltage of the power tool.

In some aspects, the PCB includes wide band gap (“WBG”) semiconductors.

In some aspects, the WBG semiconductors include Gallium Nitride (“GaN”) and/or Silicon Carbide (“SiC”).

In some aspects, the three-level or greater inverter is a cascaded H-bridge inverter or a diode clamped inverter.

In some aspects, the power source is a battery pack.

In some aspects, the battery pack has a nominal voltage of greater than 50V DC.

Embodiments disclosed herein provide a power tool including a motor, a battery pack interface, and a three-level or greater inverter for controlling power supplied by the battery pack to the motor. A switching frequency of the three-level or greater inverter is a multiple of a fundamental switching frequency of the three-level or greater inverter. A level of the three-level or greater inverter is a multiplier of the fundamental switching frequency.

In some aspects, the three-level or greater inverter is a three-level inverter, a five-level inverter, a seven-level inverter, a nine-level inverter, or an eleven-level inverter.

In some aspects, during operation of the three-level or greater inverter, a modulation voltage between two levels is given by V_{bus}/(N−1), where N is the number of levels.

In some aspects, the power tool includes an inductor and a capacitor at an output of the three-level or greater inverter, and a pulse frequency seen by the inductor is given by (N−1)f_{sw}, where f_{sw} is the switching frequency of at least one switch of the three-level or greater inverter.

In some aspects, an inductor ripple current of the three-level or greater inverter is defined according to Δi_{L}=0.25V_{BUS}/(N−1)²f_{sw}L, where L is the inductance of the inductor and V_{BUS} is a bus voltage of the power tool.

In some aspects, the three-level or greater inverter is a cascaded H-bridge inverter or a diode clamped inverter.

Power tools described herein include a motor, a power source interface configured to connect to a power source, and a printed circuit board (“PCB”) electrically connected to the motor and the power source interface. The PCB includes wide band gap (“WBG”) semiconductors, and a three-level or greater inverter configured for controlling power supplied by the power source to the motor. A topology of the three-level or greater inverter is one of a flying capacitor multi-level (“FCML”) inverter, a cascaded H-bridge inverter, or a diode clamped inverter.

Before any embodiments are explained in detail, it is to be understood that the embodiments are not limited in application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (ASICs). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a power tool, according to embodiments described here.

FIG. 2 illustrates a control system for the power tool of FIG. 1, according to embodiments described herein.

FIGS. 3A, 3B, and 3D each illustrate an example embodiment of a multi-level inverter, according to embodiments described herein.

FIG. 3C illustrates a table that includes switching state of a five-level inverter as depicted in FIG. 3B, according to embodiments described herein.

FIGS. 4A, 4B, and 4C illustrate example layouts of a PCB configured as a wide-bandgap inverter, according to embodiments described herein.

FIG. 5 illustrates an inverter circuit including a wide-bandgap semiconductor devices.

### DETAILED DESCRIPTION

Embodiments described herein relate to an electrical device such as a power tool which includes a motor, a power source, and a printed circuit board (PCB) electrically connected to the motor and the power source. In some embodiments, the PCB configured as a multi-level inverter controlling the voltage and frequency of power supplied by the power source to the motor. In some embodiments, a topology of the multi-level inverter comprises a flying capacitor multilevel (FCML) inverter. In some embodiments, a switching frequency presented to passive filter components of the inverter is a multiple of a fundamental switching frequency of the inverter, and wherein a multiplier of the fundamental switching frequency is a level of the inverter. In some embodiments, the multi-level inverter is a three-level, a five level, a seven level, a nine level, or an eleven level inverter. In some embodiments, while the multi-level inverter is operating, a modulation between levels is defined according to V_{BUS}/(N−1), where N is the number of levels. In some embodiments, the passive filter components comprise inductors and capacitors. In some embodiments, a pulse frequency seen by the inductors is defined according to (N−1)f_{sw}, where f_{sw} is the switching frequency of each switch of the multi-level inverter. In some embodiments, an inductor ripple current of the multi-level inverter is defined according to Δi_{L}=0.25V_{BUS}/(N−1)²f_{sw}L. In some embodiments, the PCB includes wide-bandgap (WBG) semiconductors. In some embodiments, the WBG semiconductors include GaN and/or SiC. In some embodiments, a topology of the multi-level inverter is a cascaded H-bridge inverter or a diode clamped inverter. In some embodiments, the motor is an AC motor. In some embodiments, power source produces a direct current (DC) voltage.

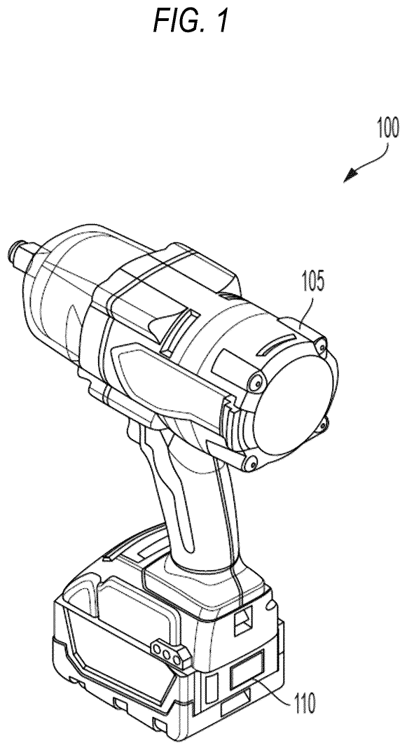

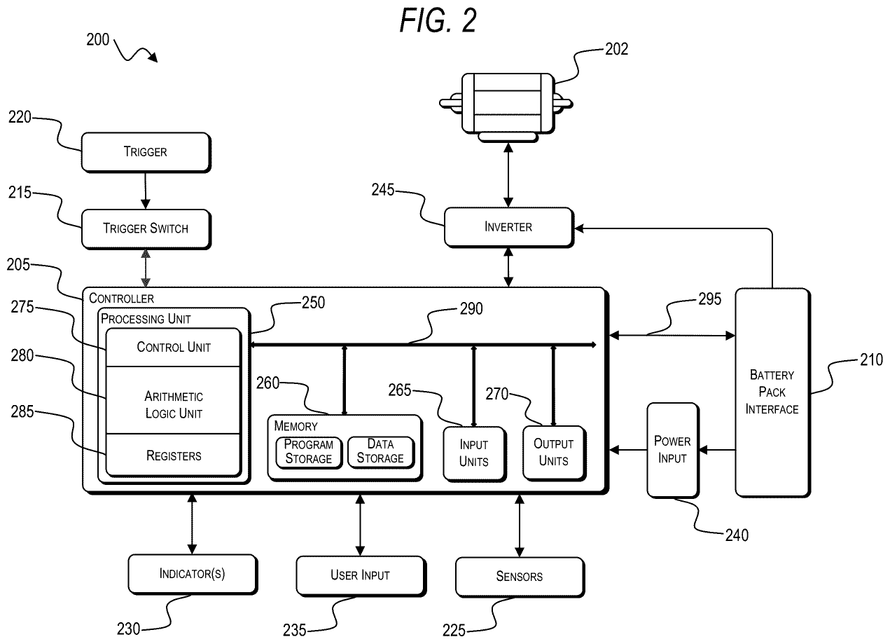

FIG. 1 illustrates a power tool 100. The power tool 100 may be, for example, an impact wrench, a drill, a ratchet, a saw, a hammer drill, an impact driver, a rotary hammer, a grinder, a blower, a trimer, etc. The power tool 100 includes a housing or a motor housing 105 which houses a motor (see FIG. 2) within the power tool 100. The power tool is configured to receive a power source 110 that provides direct current (DC) power to the various components of the power tool 100, including the motor. The power source 110 may be a power tool battery pack that is rechargeable and uses, for instance, lithium ion battery cells.

FIG. 2 illustrates a control system 200 for the power tool 100. The control system 200 includes a controller 205. The controller 205 is electrically and/or communicatively connected to a variety of modules or components of the power tool 100. For example, the illustrated controller 205 is electrically connected to a motor 202, a battery pack interface 210, a trigger switch 215 (connected to a trigger 220), one or more sensors or sensing circuits 225, one or more indicators 230, a user input module 235, a power input module 240, and an inverter or FET switching module 245. The controller 205 includes combinations of hardware and software that are operable to, among other things, control the operation of the power tool 100, monitor the operation of the power tool 100, activate the one or more indicators 230 (e.g., an LED), etc.

The controller 205 includes a plurality of electrical and electronic components that provide power, operational control, and protection to the components and modules within the controller 205 and/or the power tool 100. For example, the controller 205 includes, among other things, a processing unit 250 (e.g., a microprocessor, a microcontroller, an electronic processor, an electronic controller, or another suitable programmable device), a memory 260, input units 265, and output units 270. The processing unit 250 includes, among other things, a control unit 275, an ALU 280, and a plurality of registers 285, and is implemented using a known computer architecture (e.g., a modified Harvard architecture, a von Neumann architecture, etc.). The processing unit 250, the memory 260, the input units 265, and the output units 270, as well as the various modules or circuits connected to the controller 205 are connected by one or more control and/or data buses (e.g., common bus 290). The control and/or data buses are shown generally in FIG. 2 for illustrative purposes.

In some embodiments, the memory 260 is a non-transitory computer readable medium and includes, for example, a program storage area and a data storage area. In some embodiments, the program storage area and the data storage area include combinations of different types of memory, such as a read only memory (ROM), a random access memory (RAM) (e.g., dynamic random access memory (DRAM), synchronous dynamic random access memory (SDRAM), etc.), electronically erasable programmable read-only memory (EEPROM), flash memory, a hard disk, an secure digital (SD) card, or other suitable magnetic, optical, physical, or electronic memory devices. The processing unit 250 is connected to the memory 260 and executes software instructions that are capable of being stored in a RAM of the memory 260 (e.g., during execution), a ROM of the memory 260 (e.g., on a generally permanent basis), or another non-transitory computer readable medium such as another memory or a disc. In some embodiments, software included in the implementation of the power tool 100 is stored in the memory 260 of the controller 205. The software includes, for example, firmware, one or more applications, program data, filters, rules, one or more program modules, and other executable instructions. In some embodiments, the controller 205 is configured to retrieve from the memory 260 and execute, among other things, instructions related to the control processes and methods described herein. In other constructions, the controller 205 includes additional, fewer, or different components.

In some embodiments, the battery pack interface 210 includes a combination of mechanical components (e.g., rails, grooves, latches, etc.) and electrical components (e.g., one or more terminals) configured to and operable for interfacing (e.g., mechanically, electrically, and communicatively connecting) the power tool 100 with a battery pack. For example, power provided by the battery pack 110 to the power tool 100 is provided through the battery pack interface 210 to the power input module 240. In some embodiments, the power input module 240 includes combinations of active and passive components to regulate or control the power received from the battery pack 110 prior to power being provided to the controller 205. In some embodiments, the battery pack interface 210 also supplies power to the inverter 245 to be switched by the inverter to selectively provide power to the motor 202. The battery pack interface 210 also includes, for example, a communication line 295 for provided a communication line or link between the controller 205 and the battery pack 110.

In some embodiments, the inverter 245 is configured on a printed circuit board (“PCB”) that is electrically connected to the motor 202 and the battery pack 110. In some embodiments, the motor 202 is an alternating current (AC) motor. In such embodiments, the inverter 245 is configured to control the voltage and frequency of the power supplied by the battery pack 110 to the motor 202. In some embodiments, the PCB includes logical decision-making devices or gate drivers such as microcontrollers (MCUs), central processing units (CPUs), field programmable gate arrays (FPGAs), etc., which are coupled to power electronic devices such as transistors. In some embodiments, the PCB includes WBG semiconductors to form a WBG inverter. Herein, a “WBG semiconductor” refers to a semiconductor that has an energy band gap that is wider than silicon. Generally, silicon has an energy band gap of about 1.1 electronvolt (eV). WBG semiconductors may have an energy band gap of about 3 eV or greater. However, in some embodiments, the employed WBG semiconductor has an energy band gap that is less than 3 eV. Generally, the wider the energy band gap, the higher the critical field, which means that breakdown voltage may be larger for the same size wide band gap semiconductor formed device, relative to silicon.

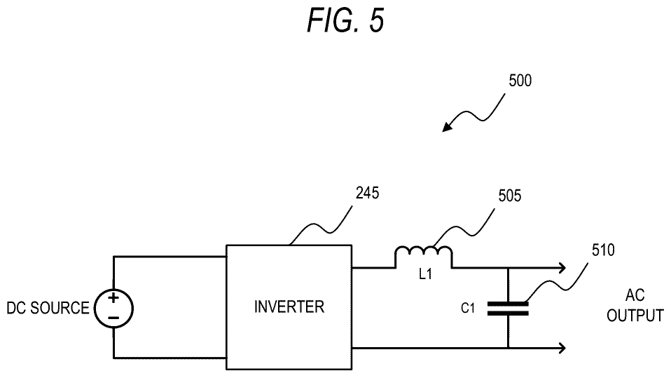

By using WBG semiconductors, the WBG inverter 245 can be mounted to smaller machines due to the smaller size of the semiconductors, the higher frequency of operation enabled by WBG semiconductors, and the higher operating temperatures. In some embodiments, employing the WBG inverter 245 enables higher speed motor operation (e.g., 75,000 to 100,000 revolutions per minute [RPM] or more as opposed to, for example, 30,000 RPM). Moreover, a WBG inverter 245 provides for a smaller size, lower switching and conduction losses, enhanced thermal conductivity, higher operating temperature, etc., relative to inverters formed with silicon-based semiconductors. As such, the WBG inverter 245 can be mounted directly to the motor 202 without incurring much if any penalty (see FIGS. 5-7B). In some embodiments, the PCB includes ceramic surface mount capacitors, which are smaller, can work at higher temperatures, and have higher reliability than, for example, aluminum electrolytic capacitors. The WBG inverter 245 enables increased power for a given motor package or the same power in a smaller motor package.

In some embodiments, the WBG inverter 245 is constructed using a multi-level (e.g., a three-level or greater) inverter topology. In some embodiments, the multi-level inverter topology generates a desired output voltage from several DC voltage levels at its input. Example multi-level inverter topologies include a cascaded h-Bridge inverter, a diode clamped inverter, and an FCML inverter.

In some embodiments, when using a multi-level inverter topology, the switching frequency that is presented to passive filter components, such as inductors and capacitors, is a multiple of the fundamental switching frequency of the inverter. In some embodiments, the multiplier of this frequency is the level of the inverter. For example, a five-level inverter with a fundamental switching frequency of 100 kilohertz (kHz), has a ripple frequency presented to the passive component filter network of 4*100 kHz or 400 kHz effective. This increase in switching frequency aids in reducing the size of the passive components. This is illustrated by considering the FCML inverter. During operation, the modulation voltage between two levels is V_{BUS}/(N−1), where N is the number of levels. The bus voltage, V_{BUS}, corresponds to, for example, a battery pack voltage of a battery pack that is connected to the power tool 100 (i.e., battery pack 110). The nominal voltage of the battery pack 110 is, for example, greater than 50V DC (e.g., 50V DC-80V DC). In some embodiments, the nominal voltage of the battery pack 110 is 72V DC-120V DC. On some embodiments, the nominal voltage of the battery pack 110 is greater than 100V DC, greater than 200V DC, or greater than 300V DC. By increasing the voltage of the battery pack 110, and therefore the bus voltage of the power tool 100, the voltage step between levels of the multi-level inverter 245 increases. The multi-level inverter 245 can be used with lower voltage battery packs 110, such as a battery pack having a nominal voltage of 12V DC-48V DC. However, a battery pack voltage of at least 50V DC is preferred for use with the multi-level inverter 245.

Additionally, the pulse frequency seen by the inductor is (N−1)f_{sw} where f_{sw} is the switching frequency of each switch. In some embodiments, the inductor ripple current of an N-level inverter (e.g., an FCML inverter) is given as: Δi_{L}=0.25V_{BUS}/(N−1)²f_{sw}L. For a given value of inductor ripple current, the FCML inverter can employ an output inductor that is (N−1)² smaller than the inductor used for a two-level inverter. By using WBG semiconductors in a multi-level inverter, significant size (e.g., volume) and weight reductions for the inverter can be achieved, along with increased power density (increased power per unit volume). Furthermore, semiconductors with lower voltage ratings can be used in the multi-level inverter to support higher system voltages. For example, lower voltage rated metal-oxide-semiconductor field-effect transistors (MOSFETs) typically have lower on-state resistance, thus decreasing the switching and conduction losses from the switches.

The indicators 230 include, for example, one or more light-emitting diodes (“LEDs”). In some embodiments, the indicators 230 are configured to display conditions of, or information associated with, the power tool 100. For example, the indicators 230 can be configured to indicate measured electrical characteristics of the power tool 100, the status of the device, etc. The user input module 235 is operably coupled to the controller 205 to, for example, select a forward mode of operation or a reverse mode of operation, a torque and/or speed setting for the power tool 100 (e.g., using torque and/or speed switches), etc. In some embodiments, the user input module 235 includes a combination of digital and analog input or output devices required to achieve a desired level of control for the power tool 100, such as one or more knobs, one or more dials, one or more switches, one or more buttons, etc.

The sensors 225 include one or more current sensors, one or more speed sensors, one or more Hall-effect sensors, one or more temperature sensors, etc. The controller 205 calculates or includes, within memory 260, predetermined operational threshold values and limits for operation of the power tool 100. For example, when a potential thermal failure (e.g., of a FET, the motor 202, etc.) is detected or predicted by the controller 205, power to the motor 202 can be limited or interrupted until the potential for thermal failure is reduced.

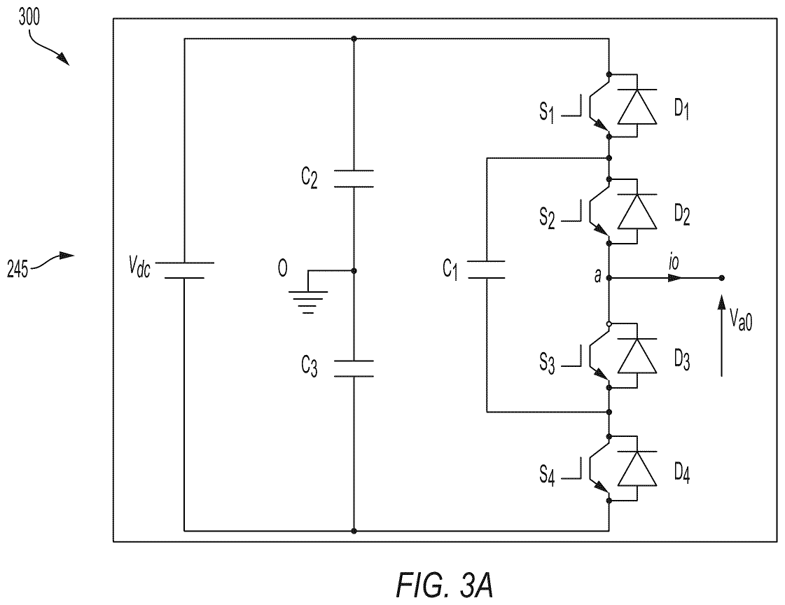

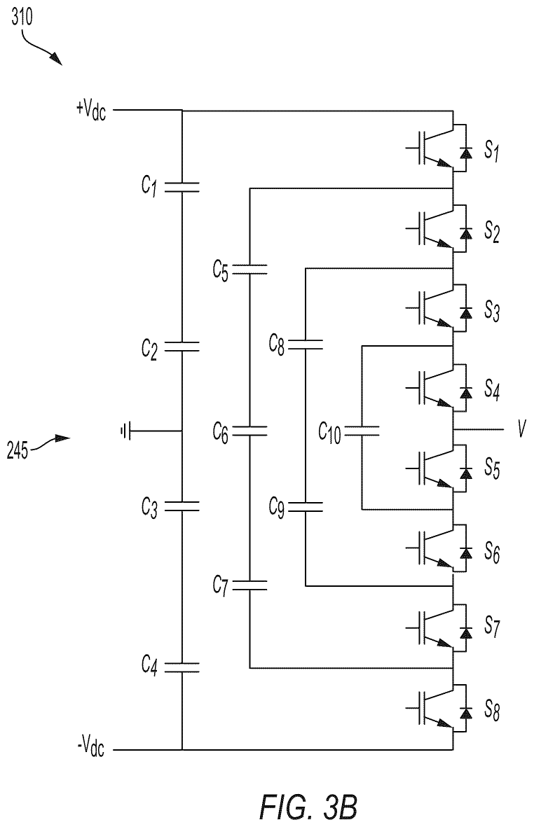

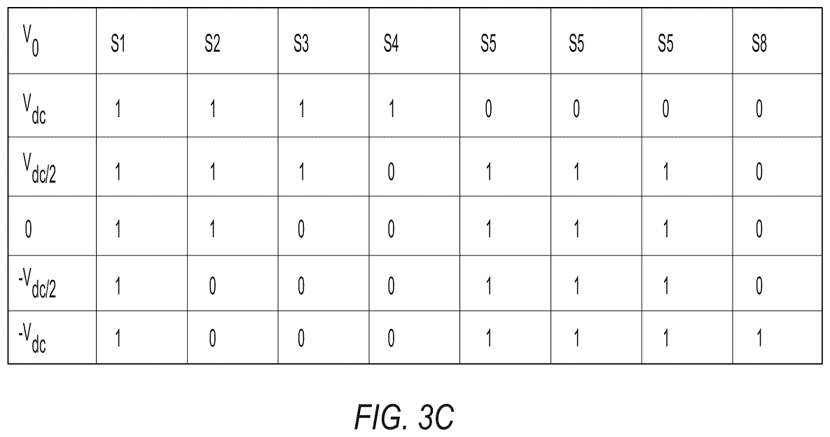

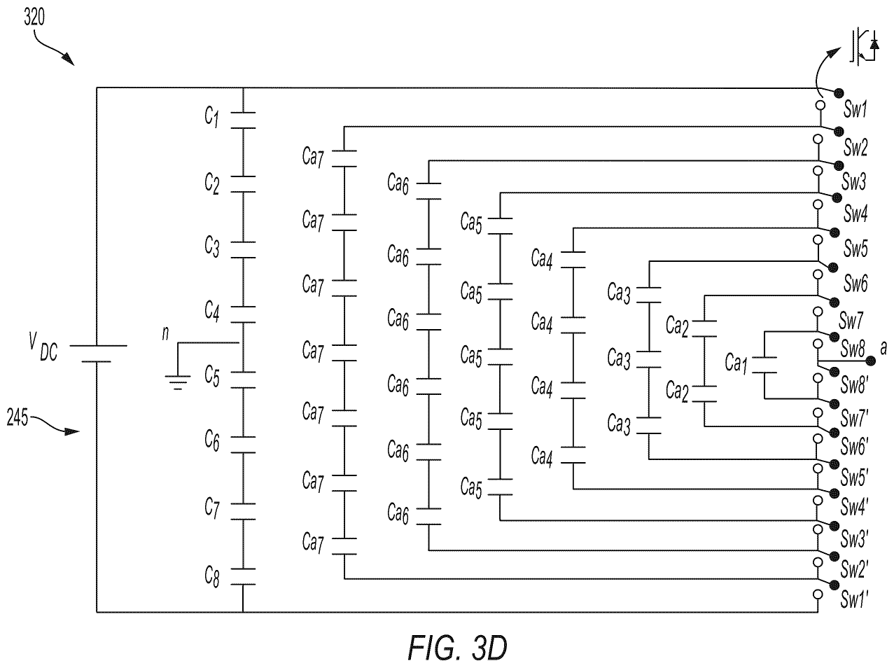

FIGS. 3A, 3B, and 3D each illustrate multi-level inverters for use in the power tool 100. FIG. 3A illustrates a three-level FCML inverter 300. FIG. 3B illustrates a five-level FCML inverter 310. FIG. 3D a nine-level FCML inverter 320. Although, multi-level FCML inverters are illustrated, another type of multi-level inverter can also be used in the power tool 100. FIG. 3C illustrates a table that includes switching states of the five-level FCML inverter 310 for driving the motor 202. Similar tables are used for driving the motor 202 with a three-level inverter, a nine-level inverter, an eleven-level inverter, etc., adjusted for the required number of switches. Each switch in the inverter 245 includes its own gate driver for driving the switch to the appropriate conduction state (i.e., ON or OFF).

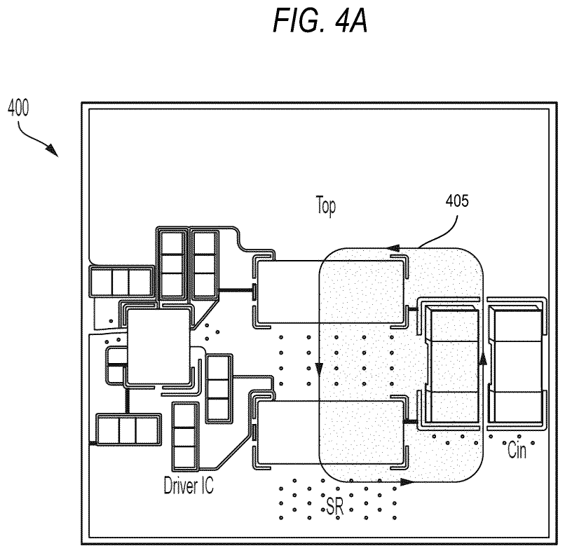

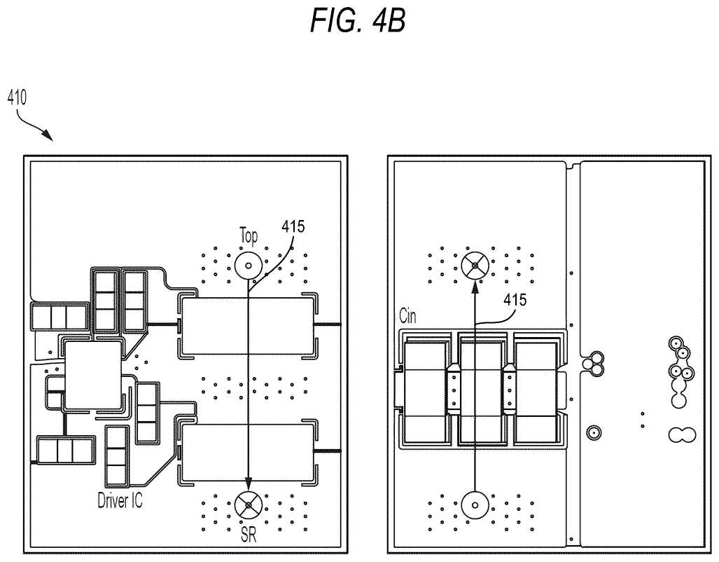

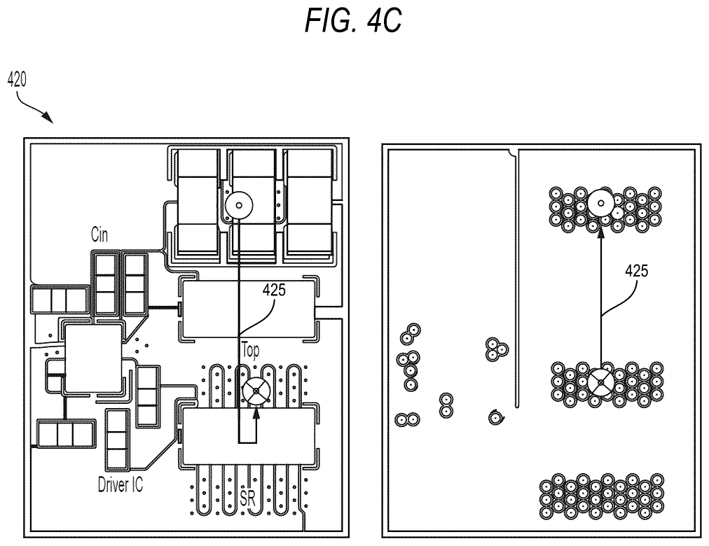

FIGS. 4A, 4B, and 4C illustrate example layouts 400, 410, and 420, respectively, of the PCB configured as the WBG inverter 245. The example layouts 400, 410, and 420 depict power flows to manage the path where the current flows and returns. The example layout 400 is a lateral power loop 405 for a WBG half bridge configuration (i.e., with input capacitors on the same side of the PCB as the power inputs). The power loop 405 generates a magnetic field that induces a current in a shield layer of the PCB, and that flows in the opposite direction to the power loop 405. The current in the shield layer generates a magnetic field to counteract the original power loop's magnetic field, which results is a cancellation of magnetic fields. The shield layer is positioned in close proximity to the power loop 405 (e.g., as a second layer of the PCB) to minimize power loop inductance in the lateral power loop configuration.

The example layout 410 is a vertical power loop 415 for a WBG half bridge configuration (i.e., with input capacitors on an opposite side of the PCB as the power inputs). As the thickness of the PCB is reduced, the area of the power loop 415 also decreases. Current flowing in opposing directions on the top and bottom layers of the PCB provide magnetic self-cancellation.

The example layout 420 is an optimized power loop 425 for WBG half bridge configuration (i.e., with input capacitors on the same side of the PCB as the power inputs). The optimized power loop 425 uses a first inner layer (right in FIG. 4C) as a power loop return path. The return path is located directly beneath the top layer of the PCB's power loop 425 (left in FIG. 4C). Such a positioning achieves the smallest physical loop area while also benefitting from magnetic field self-cancellation.

FIG. 5 illustrates an inverter circuit 500 for the power tool 100. The inverter circuit 500 includes the multi-level inverter 245 and an output filter that includes an inductor 505 and a capacitor 510. The inductor 505 and capacitor 510 have lower respective inductance and capacitance values than would be used for a two-level inverter. In some embodiments, the capacitor 510 is a ceramic surface mount capacitor, which is smaller, can operate at higher temperatures, and has greater reliability than, for example, an aluminum electrolytic capacitor.

Thus, embodiments described herein provide, among other things, a power tool including a multi-level inverter for driving a motor. Various features and advantages are set forth in the following claims.

What is claimed is:

1. A power tool comprising:
a motor;
a power source interface configured to connect to a power source; and
a printed circuit board (“PCB”) electrically connected to the motor and the power source interface, the PCB including a three-level or greater inverter configured for controlling power supplied by the power source to the motor.

2. The power tool of claim 1, wherein the three-level or greater inverter is a flying capacitor multi-level (“FCML”) inverter.

3. The power tool of claim 1, wherein:
a switching frequency of the three-level or greater inverter is a multiple of a fundamental switching frequency of the three-level or greater inverter; and
a level of the three-level or greater inverter is a multiplier of the fundamental switching frequency.

4. The power tool of claim 3, wherein the three-level or greater inverter is a three-level inverter, a five-level inverter, a seven-level inverter, a nine-level inverter, or an eleven-level inverter.

5. The power tool of claim 4, wherein, during operation of the three-level or greater inverter, a modulation voltage between two levels is given by V_{bus}/(N−1), where N is a number of levels of the three-level or greater inverter.

6. The power tool of claim 5, further comprising an inductor and a capacitor at an output of the three-level or greater inverter.

7. The power tool of claim 6, wherein a pulse frequency seen by the inductor is given by (N−1)f_{sw}, where f_{sw} is a switching frequency of at least one switch of the three-level or greater inverter.

8. The power tool of claim 7, wherein an inductor ripple current of the three-level or greater inverter is defined according to Δi_{L}=0.25V_{BUS}/(N−1)²f_{sw}L, where L is the inductance of the inductor and V_{BUS} is a bus voltage of the power tool.

9. The power tool of claim 1, wherein the PCB includes wide band gap (“WBG”) semiconductors.

10. The power tool of claim 9, wherein the WBG semiconductors include Gallium Nitride (“GaN”) and/or Silicon Carbide (“SiC”).

11. The power tool of claim 1, wherein the three-level or greater inverter is a cascaded H-bridge inverter or a diode clamped inverter.

12. The power tool of claim 1, wherein the power source is a battery pack.

13. The power tool of claim 12, wherein the battery pack has a nominal voltage of greater than 50V DC.

14. A power tool comprising:
a motor;
a battery pack interface configured to receive a battery pack;
a three-level or greater inverter for controlling power supplied by the battery pack to the motor, wherein
a switching frequency of the three-level or greater inverter is a multiple of a fundamental switching frequency of the three-level or greater inverter, and
a level of the three-level or greater inverter is a multiplier of the fundamental switching frequency.

15. The power tool of claim 14, wherein the three-level or greater inverter is a three-level inverter, a five-level inverter, a seven-level inverter, a nine-level inverter, or an eleven-level inverter.

16. The power tool of claim 15, wherein, during operation of the three-level or greater inverter, a modulation voltage between two levels is given by V_{bus}/(N−1), where N is a number of levels.

17. The power tool of claim 16, further comprising:
an inductor and a capacitor at an output of the three-level or greater inverter,
wherein a pulse frequency seen by the inductor is given by (N−1)f_{sw}, where f_{sw} is a switching frequency of at least one switch of the three-level or greater inverter.

18. The power tool of claim 17, wherein an inductor ripple current of the three-level or greater inverter is defined according to Δi_{L}=0.25V_{BUS}/(N−1)²f_{sw}L, where L is the inductance of the inductor and V_{BUS} is a bus voltage of the power tool.

19. The power tool of claim 14, wherein the three-level or greater inverter is a cascaded H-bridge inverter or a diode clamped inverter.

20. A power tool comprising:
a motor;
a power source interface configured to connect to a power source; and
a printed circuit board (“PCB”) electrically connected to the motor and the power source interface, wherein the PCB includes:
wide band gap (“WBG”) semiconductors, and
a three-level or greater inverter configured for controlling power supplied by the power source to the motor,
wherein a topology of the three-level or greater inverter is one of a flying capacitor multi-level (“FCML”) inverter, a cascaded H-bridge inverter, or a diode clamped inverter.
